(19) United States
(12) Patent Application Publication
(10) Pub. No.: US 2009/0273196 A1
(43) Pub. Date: Nov. 5, 2009

(54) Front Guard of Working Vehicle

(75) Inventors: Hiroaki Ayabe, Fukuoka (JP); Nagahiro Ogata, Fukuoka (JP); Kouichi Takata, Fukuoka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Yanmar Co., Ltd., Osaka (JP)

(21) Appl. No.: 12/160,067

(22) PCT Filed: Aug. 25, 2006
(86) PCT No.: PCT/JP2006/316713

§ 371 Date: Sep. 26, 2008

(30) Foreign Application Priority Data
Jan. 16, 2006 (JP) 2006-007215

(51) Int. Cl. B60R 19/52

(52) U.S. Cl. 293/115

(57) ABSTRACT

A front guard (10) is provided for a working vehicle. The front guard (10) is attached to a bracket (11) fixed at the front of a machine body frame and is placed in front of a bonnet (30). The front end of the front guard (10) is located rearward from the front end of front wheels (8) of the working vehicle. The front guard does not project forward of the machine body so that the guard does not spoil workability, whereby the guard is easy to be assembled and has high strength.

### TECHNICAL FIELD

The invention relates to a front guard disposed in front of a vehicle body of a working vehicle.

### BACKGROUND ART

As well known, in a conventional working vehicle, a structure such as a front guard is disposed in front of a vehicle body so as to protect implements, such as a radiator and an oil cooler, which are disposed in front of the vehicle body, from unexpected shock or so on during working.

However, when a front guard is arranged in a front portion of a vehicle, the front guard is projected forward so as to increase the turning radius of the vehicle, whereby the workability is spoiled. The forward projected front guard may collide with others at the time of working or traveling so as to be broken.

When the bracket to which the front guard is attached is formed as an integral welded structure, the production cost is increased, and the dispersion of production accuracy of the front guard, which is also a welded structure, and the bracket makes the assembly difficult.

The front guard obstructs the maintenance of the bonnet part.

Then, the front guard is desired to be rotatable easily so as to be opened and closed. However, when the fixation of the front guard is incomplete, the shock resistance is spoiled.

Furthermore, the front guard may obstruct an operator's eyeshot so as to spoil the workability.

### BRIEF DESCRIPTION OF THE DRAWINGS

### Object

An object to be achieved is to provide a front guard which is not projected forward, does not spoil the workability, is easy to be assembled, and has high intensity.

### Way for Solving the Problem

A front guard of a working vehicle according to the present invention is attached to a bracket fixed to a front portion of a vehicle body frame and is arranged in front of the bonnet. The front guard is characterized in that a front end of the front guard is disposed behind a front end of a front wheel of the working vehicle.

With regard to the front guard of the working vehicle according to the present invention, the front guard comprises a vertical frame extended vertically and a horizontal frame extended horizontally, and a triangular reinforcement part is provided on a front or rear surface of the vertical frame.

With regard to the front guard of the working vehicle according to the present invention, a lower portion of the front guard is fore-and-aft rotatably supported on the bracket, and a rotation stopper is formed in a lower rear portion of the front guard. The rotation stopper is substantially L-like shaped when viewed in side so as to have a rear surface and a lower surface. The rear surface of the rotation stopper is adapted to contact a front surface of the vehicle body frame. The lower surface of the rotation stopper is adapted to contact an upper surface of the bracket.

With regard to the front guard of the working vehicle according to the present invention, the bracket comprises left and right independent members.

With regard to the front guard of the working vehicle according to the present invention, the front guard is formed into a substantially ladder-like shape, and a lower portion of the front guard is fore-and-aft rotatably supported on the bracket so that the front guard when rotated forwardly downward serves as a step.

With regard to the front guard of the working vehicle according to the present invention, a lower portion of the front guard is fore-and-aft rotatably supported on the bracket, a pin is inserted into holes penetrating both of the front guard and the bracket so as to fix the front guard to the bracket, and clearance is formed between the penetrating holes and the pin.

With regard to the front guard of the working vehicle according to the present invention, the front guard comprises a vertical frame extended vertically and a horizontal frame extended horizontally, and the vertical frame is offset from an upright part of a bonnet grill when viewed in front.

With regard to the front guard of the working vehicle according to the present invention, a top of the front guard is projected slightly upward from a line of sight of an operator on an operation seat toward an upper front portion of the bonnet so as to be seen by the operator, and so as not to obstruct the operator's eyeshot.

### EFFECT OF THE INVENTION

With regard to the front guard of a working vehicle according to the present invention, the front end of the front guard is disposed behind the front end of the front wheel of the working vehicle. Accordingly, the turning radius of the vehicle is not increased, whereby the vehicle is prevented from spoiling the turning ability thereof and from colliding with an obstacle.

With regard to the front guard of the working vehicle according to the present invention, the front guard comprises a vertical frame extended vertically and a horizontal frame extended horizontally, and a triangular reinforcement part is provided on a front or rear surface of the vertical frame. By providing the reinforcement part in consideration of section modulus, the front guard becomes hard to be bent.

With regard to the front guard of the working vehicle according to the present invention, a lower portion of the front guard is fore-and-aft rotatably supported on the bracket, and a rotation stopper is formed in a lower rear portion of the front guard. The rotation stopper is substantially L-like shaped when viewed in side so as to have a rear surface and a lower surface. The rear surface of the rotation stopper is adapted to contact a front surface of the vehicle body frame. The lower surface of the rotation stopper is adapted to contact an upper surface of the bracket. Due to this structure, stress applied on the front guard is dispersed into vertical and horizontal directions, thereby ensuring high rigidity of the front guard.

With regard to the front guard of the working vehicle according to the present invention, the bracket comprises left and right independent members. Accordingly, the front guard can be produced inexpensively because the front guard does not need high dimensional accuracy and is simplified in structure. Further, the front guard is easy in assembly and adjustment.

With regard to the front guard of the working vehicle according to the present invention, the front guard is formed into a substantially ladder-like shape, and a lower portion of the front guard is fore-and-aft rotatably supported on the bracket so that the front guard rotated forwardly downward serves as a step. By using the lower portion of the front guard as the step, it is easy to go up to the bonnet part, whereby the workability of the maintenance is improved.

With regard to the front guard of the working vehicle according to the present invention, a lower portion of the front guard is fore-and-aft rotatably supported on the bracket, a pin is inserted into holes penetrating both of the front guard and the bracket so as to fix the front guard to the bracket, and clearance is formed between the penetrating holes and the pin. Accordingly, the front guard can be produced inexpensively because the front guard does not need high dimensional accuracy and is simplified in structure. Further, due to the simple rotation structure of the front guard, a user's labor for fixing and rotating the front guard is reduced.

With regard to the front guard of the working vehicle according to the present invention, the front guard comprises a vertical frame extended vertically and a horizontal frame extended horizontally, and the vertical frame is offset from an upright part of a bonnet grill when viewed in front. Accordingly, the gap between the front guard and an object to be protected by the front guard is reduced so as to reduce the forward projection of the front guard.

With regard to the front guard of the working vehicle according to the present invention, a top of the front guard is projected slightly upward from a line of sight of an operator on an operation seat toward an upper front portion of the bonnet so as to be seen by the operator, and so as not to obstruct the operator's eyeshot. Accordingly, the front guard protects the vehicle body without spoiling the operability.

### BRIEF DESCRIPTION OF THE DRAWINGS

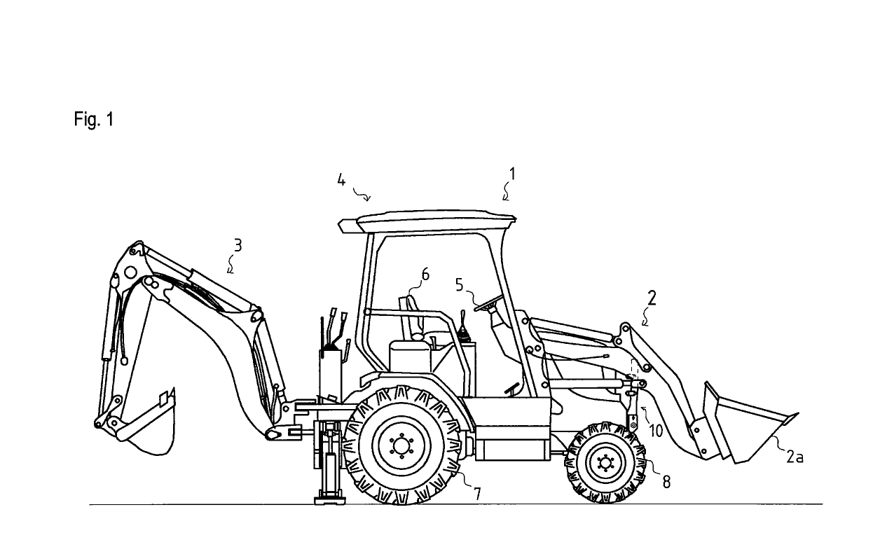

FIG. 1 is a side view of an entire working vehicle according to an embodiment of the present invention.

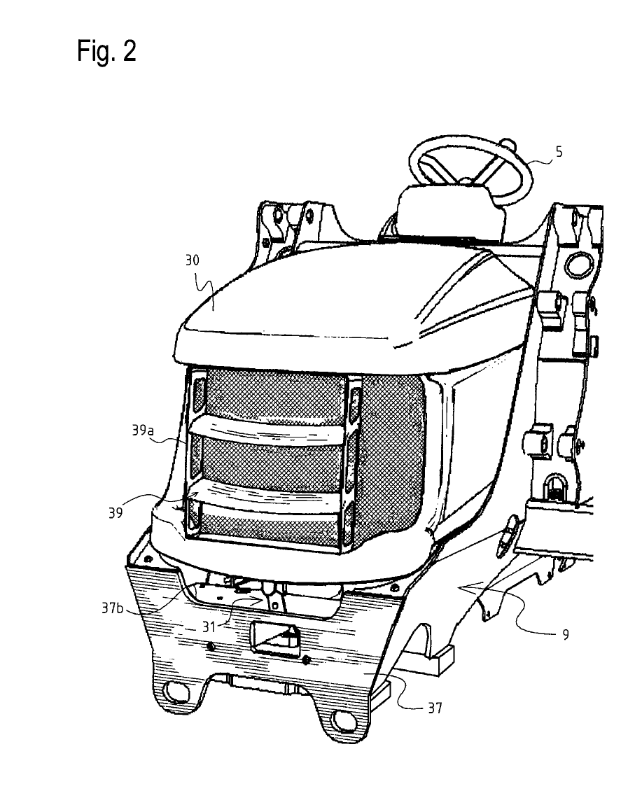

FIG. 2 is a perspective view of a front portion of the vehicle (when a front guard is not mounted).

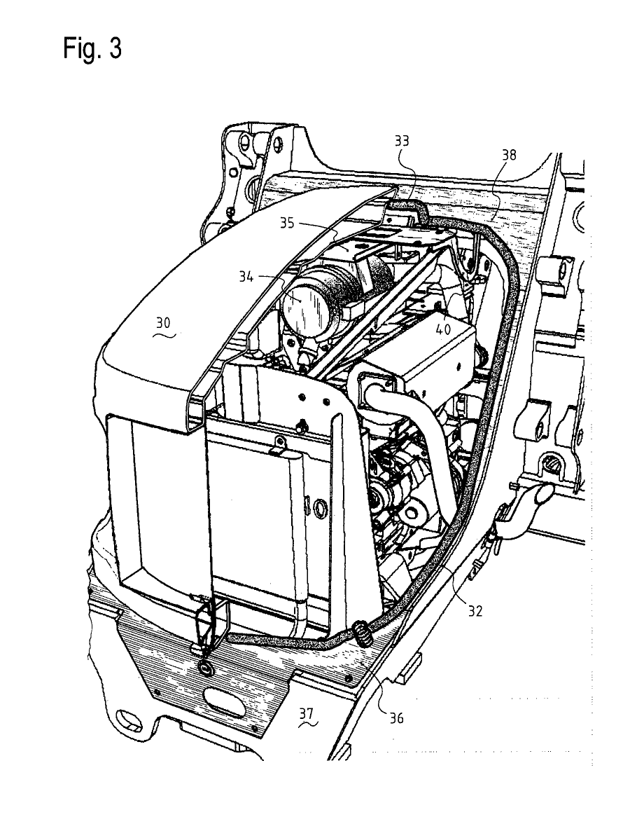

FIG. 3 is a perspective view partly in section of the front portion of the working vehicle.

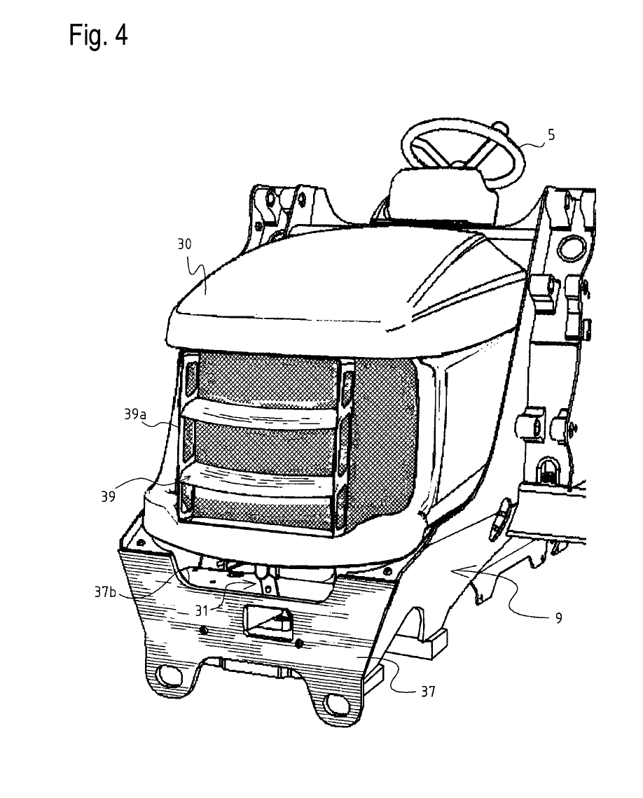

FIG. 4 is a perspective view of a front guard.

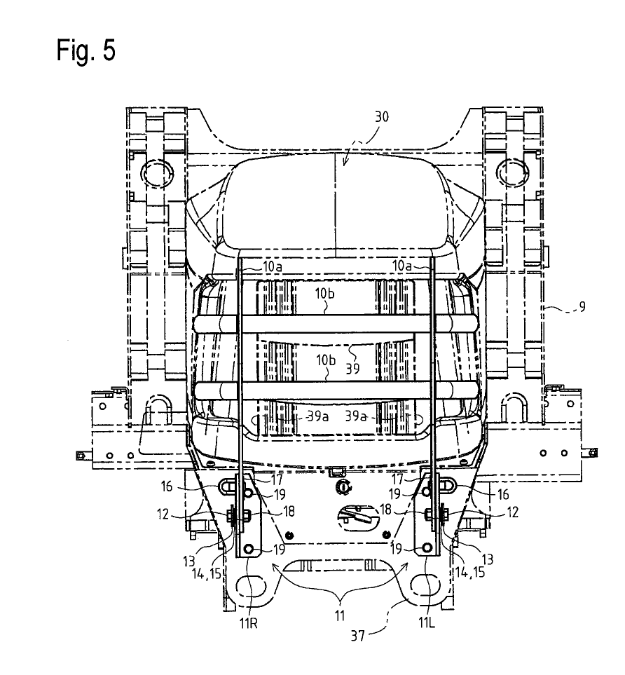

FIG. 5 is a front view of the front guard.

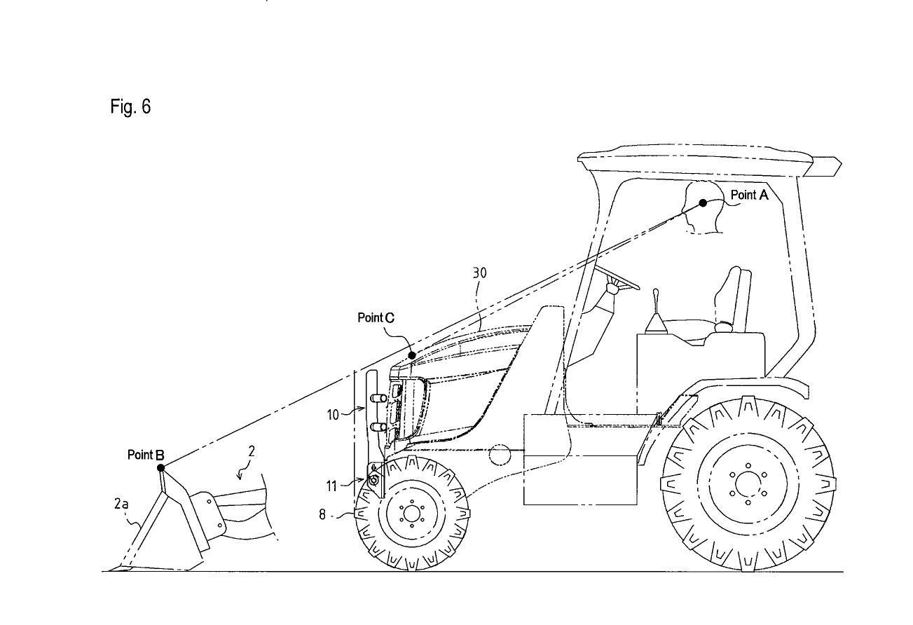

FIG. 6 is a schematic side view of arrangement of the front guard and an operator's ken for working.

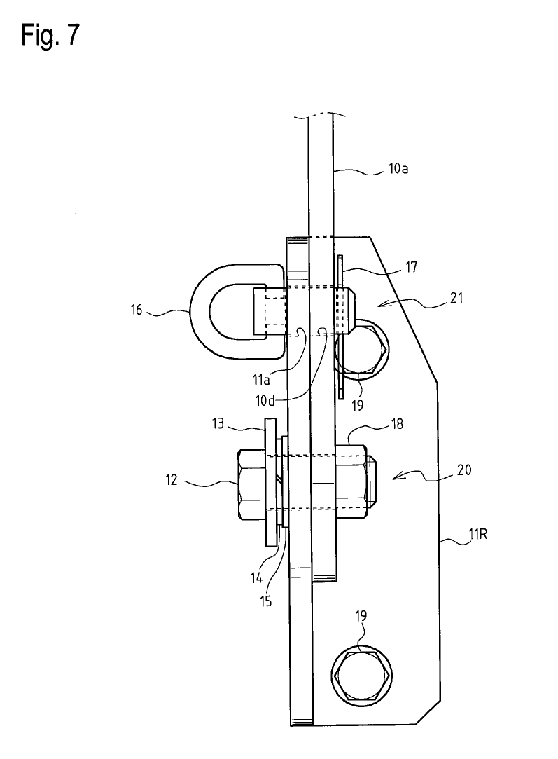

FIG. 7 is a front view of a front guard attachment part.

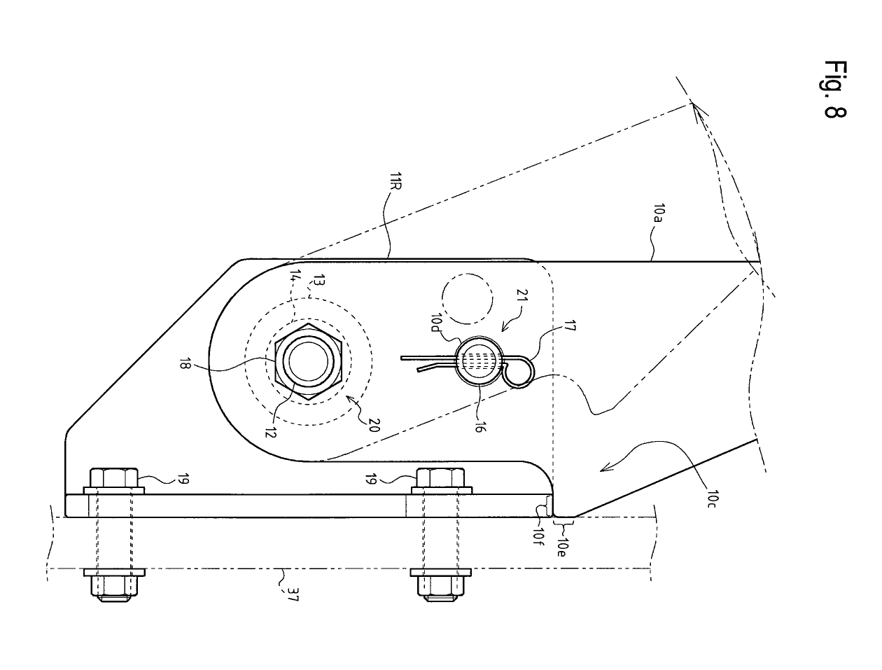

FIG. 8 is a side view of the front guard attachment part.

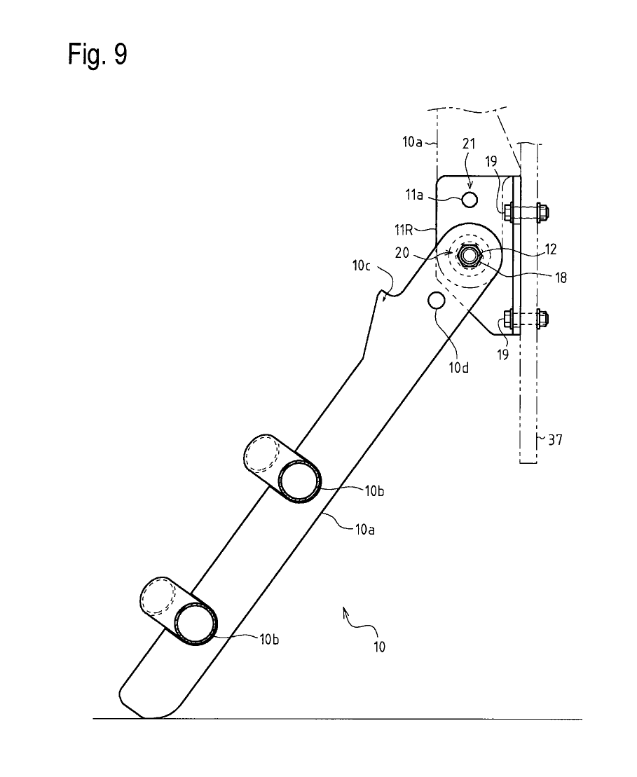

FIG. 9 is a side view of the front guard rotated forward.

### DESCRIPTION OF NOTATIONS

1 Working Vehicle
8 Front Wheel
9 Vehicle Body Frame
10 Front Guard
11 Bracket

### BEST MODE FOR CARRYING OUT THE INVENTION

A mode for carrying out the invention will be described.

First of all, a working vehicle according to an embodiment as an application of the invention will be described with reference to FIG. 1.

As shown in FIG. 1, a working vehicle 1 is a tractor-loader-backhoe equipped with a loader 2 and an excavator 3. An operation section 4 is provided at a center portion of working vehicle 1. Loader 2 is disposed in front of operation section 4, and excavator 3 is disposed behind operation section 4. Working vehicle 1 is provided with front wheels 8 and rear wheels 7 so as to enable to travel while having loader 2 and excavator 3.

A steering wheel 5 and an operation seat 6 are disposed in operation section 4. Operation devices for traveling and for loader 2 are disposed beside operation seat 6. Therefore, operation section 4 is provided for steering operation of working vehicle 1 and for operation of loader 2.

Loader 2 serving as a device for loading particles has lift arms, which are connected to side portions of working vehicle 1 and are extended forward, and has a bucket 2a attached on tips of the lift arms.

Excavator 3 is detachably attached onto a rear portion of working vehicle 1. Operation devices for excavator 3 are provided behind operation seat 6.

A structure of a front portion of working vehicle 1 will now be described with reference to FIGS. 2 and 3.

In this regard, FIGS. 2 and 3 show a state of the working vehicle before it is provided with a front guard serving as a subject of the invention.

As shown in FIG. 2, working vehicle 1 has vehicle body frames 9 extended fore-and-aft and disposed on left and right sides, and is provided with a bonnet 30 on vehicle body frames 9 at a front portion thereof. Bonnet 30 is made of resin and is formed in a hollow structure. Bonnet 30 is disposed in front of operation section 4 of working vehicle 1 so as to enclose an engine disposed on frames 9. In bonnet 30 are disposed the engine with engine attachments such as a radiator, a muffler and an air cleaner 34, a hydraulic pump, an oil cooler and so on.

Bonnet 30 openably closes on frames 9, so that bonnet 30 is opened by upwardly rotating a front portion thereof. In this regard, each of arms 40 is fixed at one end thereof to an inner side surface of a rear portion of bonnet 30, and is rotatably supported at a rear end thereof by frame 9 through a hinge.

Bonnet 30 is integrally formed to have parts covering the top, right, left and front surfaces of the engine. Bonnet 30 is retained at a laterally middle front and lower portion thereof by a locking mechanism 31 so as to hold its closing state. Locking mechanism 31 is interposed between frames 9 and bonnet 30, and includes a locking stay mounted on bonnet 30 and a hook provided on frames 9. When bonnet 30 closes and the stay and hook are engaged with each other, bonnet 30 is locked to frames 9.

Frames 9 are provided at front ends thereof with a front plate 37 so as to be fixedly connected to each other through front plate 37. In the state without a cover 36 as shown in FIG. 2, front plate 37 is provided at a laterally middle upper portion thereof with a notch 37b through which locking mechanism 31 is visible. Due to the downward notch at the upper middle portion of front plate 37, when frames 9 and bonnet 30 are engaged with each other, locking mechanism 31 is visible so as to facilitate positional adjustment of bonnet 30 and locking mechanism 31.

Right and left frames 9 are provided with a rib 38 inside of their front portions, such as to be adapted to fit along a bottom peripheral edge of bonnet 30. In other words, rib 38 projects from frames 9 to the periphery of the engine room. A seal 32 is fitted onto rib 38 so as to seal a gap between frames 9 and bonnet 30. Seal 32 contacts the bottom peripheral edge of bonnet 30 so as to prevent the edge of bonnet 30 from introducing air or water thereinto. Bonnet 30 is provided at a front surface thereof with an opening (a bonnet grill 39) serving as a cooling air intake. The cooling air introduced into bonnet 30 through this opening passes the radiator, cools the engine, and is exhausted downward. Seal 32 contacting the bottom peripheral edge of bonnet 30 prevents the cooling air from leaking from the gap between the edge of bonnet 30 and frames 9 (rib 38).

As shown in FIG. 3, cover 36 is provided to cover notch 37b of front plate 37, the front upper surface of frame 9 and so on. Cover 36 is a plate bent in a reversed L-like shape when viewed in side. Cover 36 is formed to have a substantially trapezoidal front surface such as to cover notch 37b. Cover 36 is shaped at an upper surface thereof so as to fit a front bottom edge of bonnet 30 for closing gaps on front upper surfaces of frames 9. Cover 36 is connected at a rear end thereof to rib 38. Seal 32 is fitted onto a rear edge of the upper surface of cover 36 so as to prevent air or water from entering the edge of bonnet 30.

Air cleaner 34 is disposed in a vacant space in the engine room. In this embodiment, stay 35 is fixed to rib 38 and is extended forward from rib 38 and air cleaner 34 is disposed in the upper middle space in bonnet 30 and is supported by stay 35 without no additional support member standing from the lower portion of frames 9, thereby enhancing an available space in bonnet 30. Therefore, stay 35 serving as the member for supporting air cleaner 34 does not obstruct the airflow in bonnet 30. A seal 33 is provided on the portion of rib 38 surrounding stay 35 so as to prevent air from leaking out through the portion.

Description of the working vehicle serving as an application of the invention is concluded.

A state of the working vehicle provided with the front guard serving as the subject of the invention will now be described with reference to FIGS. 4 to 9.

As shown in FIG. 4, a front guard 10 is disposed just in front of bonnet grill 39 at the front portion of bonnet 30.

Front guard 10 includes a pair of right and left vertical frames 10a extended vertically and a plurality of vertically aligned horizontal frames 10b extended laterally horizontally in parallel, and is rotatably supported by a bracket 11 disposed on a front surface of front plate 37.

As shown in FIG. 4, each of vertical frames 10a is a long flat plate rotatably supported which is expanded forward or rearward at a lower portion thereof for reinforcement, and the expansion shape is determined so as to have an appropriate modulus of section considering a bending stress applied thereon. As shown in FIGS. 8 and 9, the plate as each of vertical frames 10a has a surface extended in the fore-and-aft direction, so that the fore-and-aft width of a lower portion of the surface is longer than the fore-and-aft width of an upper portion thereof. Further, each vertical frame 10a has a pivoted portion at a lower portion thereof, and is formed with a substantially triangularly rearward projecting reinforcement part 10c at a lower rear portion thereof adjacently above the pivoted portion.

Accordingly, reinforcement parts 10c serve as support parts reinforcing the lower portions of respective vertical frames 10a, and also serve as stoppers for retaining vertical frames 10a that are extended vertically when front guard 10 has been rotated rearward, as described later.

Each of horizontal frames 10b is a pipe bent at right and left ends thereof rearwardly slantwise on a horizontal surface so as to fit the shape of the front end portion of bonnet 30 and has a lateral width that is slightly longer than the lateral width of bonnet 30.

In this way, front guard 10 comprises vertical frames 10a extended vertically and horizontal frames 10b extended horizontally, and triangular reinforcement part 10c is provided on the front or rear surface of each of vertical frames 10a, whereby front guard 10 is hard to be bent.

The pair of right and left vertical frames 10a are disposed in parallel. The pair of upper and lower frames 10b those are laterally spanned between right and left vertical frames 10a and are joined to upper half portions of vertical frames 10a by welding. Vertical frames 10a are higher at tops thereof than the top of bonnet grill 39, and are disposed forward from the front ends of horizontal frames 10b, thereby protecting the front portion of bonnet 30.

In this embodiment, the front guard comprises the pair of vertical frames 10a and the pair of horizontal frames 10b. However, the front guard as an application of the present invention is not limited in shape and structure. The number and shape of the members may be changed to correspond to allowable bending stress and protection range.

As shown in FIG. 4, bracket 11 includes a pair of right and left independent brackets 11R and 11L. Bracket 11L is a member, such as a steel plate, which is substantially L-like bent when viewed in plan so as to have two side surfaces. The surface of bracket 11L to be attached (to contact front plate 37) is provided with a pair of upper and lower bores for passing respective bolts 19 for fastening bracket 11L to the main body. The outer surface of bracket 11L is formed with a hole for passing a bolt 12 for fastening vertical frame 10a to bracket 11L, and with a penetrating hole 11a for passing a retaining pin 16. Bracket 11R is formed laterally symmetric with bracket 11L.

As shown in FIGS. 4 and 5, bracket 11 has the left and right independent structures of brackets 11L and 11R, and is fixed to front plate 37 by bolts 19.

With regard to attachment of brackets 11L and 11R, the lateral and longitudinal slant of each of the left and right brackets can be adjusted independently of each other so that the degree of freedom of the attachment is higher than that of the case of a bracket 11 constructed integrally. Accordingly, at the time of attaching front guard 10, even if either bracket 11L or 11R has a dimension error, the individual adjustment of brackets 11L and 11R to be attached can absorb the dimension error. Thus, even if each of brackets 11L and 11R is an integral welded structure liable to have the dimension error, it can be easily attached.

In this way, since bracket 11 comprises a pair of left and right independent members (brackets 11L and 11R), front guard 10 can be manufactured inexpensively and can be assembled and adjusted easily.

As shown in FIG. 5, when viewed in front, vertical frames 10a of front guard 10 is offset from respective upright parts 39a of bonnet grill 39 positioned behind vertical frames 10a.

Bonnet grill 39 as an opening portion for introducing cooling air is formed in the front surface of bonnet 30, and upright parts 39a are provided vertically in bonnet grill 39 so as to reinforce the opening portion and support a net or the like provided therein. Upright parts 39a do not overlap respective vertical frames 10a when viewed in front. Therefore, even if front guard 10 is stressed and bent rearward, front guard 10 does not touch any of upright parts 39a.

Accordingly, the clearance between front guard 10 and bonnet 30 is reduced so as to reduce the forward projection of front guard 10.

In this way, since front guard 10 comprises vertical frames 10a extended vertically and horizontal frames 10b extended horizontally, and vertical frames 10a are offset from respective upright parts 39a of bonnet grill 39 when viewed in front, the gap between front guard 10 and the object (bonnet 30) to be protected by front guard 10 is reduced so as to reduce the forward projection of front guard 10.

As shown in FIG. 6, front guard 10 is configured so that, when front guard 10 is attached vertically, front guard 10 is disposed behind front ends of front wheels 8. In other words, the front end of front guard 10 is disposed behind the front ends of front wheels 8.

In this way, when front guard 10 is attached to bracket 11 fixed to the front portion of vehicle body frame 9 and is arranged in front of bonnet 30, the front end of front guard 10 is disposed behind the front ends of front wheels 8. Accordingly, the turning radius of the vehicle is not increased, whereby the vehicle is prevented from spoiling the turning ability thereof and from colliding with an obstacle.

Further, the top of front guard 10 is substantially as high as the front top of bonnet 30 so as to be seen by the operator sitting on operation seat 6, however, so as not to obstruct the operator's eyeshot.

More specifically, as shown in FIG. 6, a point A is assumed on the center of the operator's head (or eyes), and a point B indicates the minimum height of the top or front end of bucket 2a (or a front-mounted working device) when lowered bucket 2a is put on the ground. A line connecting points A and B does not intersect front guard 10. The front top of bonnet 30 is indicated as a point C. A line connecting points A and C intersects front guard 10. In this way, the front guard is determined in position, size and so on so that front guard 10 is visible at the top thereof. In other words, when the operator's eyeshot (the line connecting points A and B) is focused on the top or front end of bucket 2a, the top of front guard 10 is disposed lower than the eyeshot, so that only the top of front guard 10 is seen above bonnet 30. In this way, when bucket 2a is lowered, the eyeshot to the top of bucket 2a for working is not obstructed by the top of front guard 10, however, the top of front guard 10 constantly exists in the ken for working so as to be focused for turning the working vehicle.

The top of front guard 10 is projected slightly upward from the eyeshot of the operator on operation seat 4 toward the upper front portion of bonnet 30 so as to be seen by the operator, and so as not to obstruct the operator's eyeshot, whereby the vehicle body is protected without spoiling the operability.

As shown in FIGS. 7 and 8, a fulcrum part 20 is provided at the lower portion of each of vertical frames 10a so as to serve as a rotation fulcrum of each of vertical frames 10a. Fulcrum part 20 comprises bolt 12, a washer 13, a spring washer 14, a washer 15 and a nut 18. Vertical frame 10a is rotatably supported by bolt 12 at fulcrum part 20. Bolt 12 penetrates washer 13, spring washer 14 and washer 15. Nut 18 is screwed up with a certain torque so as to generate a certain resistance against the rotation of vertical frame 10a.

The torque for screwing up nut 18 is set so as to prevent front guard 10 from falling by its own weight, however, so as to allow front guard 10 to be easily rotated by hand.

As shown in FIGS. 7 and 8, a fixing part 21 comprises retaining pin 16, a snap pin 17 and penetrating holes 10d and 11a. At fixing part 21, when penetrating holes 10d and 11a overlap each other so as to be opened for passage to each other, pin 16 is inserted into the holes so as to prevent the rotation of vertical frame 10a, whereby pin 16 serves as a rotation stopper of front guard 10. Some clearance, that is, a gap is formed between holes 10d and 11a and pin 16. Accordingly, it is not necessary for the holes to have high accuracy in location relative to each other, thereby reducing costs for forming the holes, and thereby facilitating the assembly using the holes. At the time of fixing front guard 10, snap pin 17 is inserted into a pin hole 16a bored in pin 16 so as to prevent pin 16 from falling off from holes 10d and 11a. To rotate front guard 10, snap pin 17 is removed and pin 16 is pulled out so as to release front guard 10, and then front guard 10 is rotated forward centering on fulcrum part 20. Due to this construction, pin 16 can be inserted and removed easily, so that, in comparison with a front guard fixed firmly with bolts or the like, front guard 10 can be easily rotated forward so as to open bonnet 30, thereby facilitating maintenance.

In this way, the lower portion of front guard 10 is fore-and-aft rotatably supported on bracket 11, pin 16 is inserted into holes 10d and 11a penetrating respective front guard 10 and bracket 11 so as to fix front guard 10 to bracket 11, and the clearance is formed between holes 10d and 11a and pin 16. Accordingly, front guard 10 can be produced inexpensively because the structure for attaching front guard 10 to bracket 11 and for rotating front guard 10 relative to bracket 11 is simple. Further, due to the simple structure for rotating front guard 10, a user's labor in rotating front guard 10 for maintenance or for another purpose is reduced.

A top portion of reinforcement part 10c has a lower side surface which is adapted to contact a top portion of bracket 11R (or 11L) so as to prevent further rearward rotation of vertical frame 10a, thereby serving as a rotation stopper.

A rear end of reinforcement part 10c serving as the rotation stopper is L-like shaped when viewed in side so as to have a rear surface 10e and a lower surface 10f. Rear surface 10e is adapted to contact the front surface of front plate 37, and lower surface 10f is adapted to contact the upper surface of bracket 11, so that front plate 37 and bracket 11R (11L) simultaneously contact the two surfaces of reinforcement part 10c so as to serve as respective rotation stoppers.

As shown in FIG. 8, when fixed front guard 10 is stressed rearward, each of vertical frames 10a tends to rotate rearward centering on fulcrum part 20 so as to substantially horizontally rearwardly stress pin 16 and vertical frame 10a at fixing part 21. Simultaneously, due to the rotation stopper function of reinforcement part 10c, front guard 10 is prevented from rotating further rearward, thereby substantially vertically downwardly stressing bracket 11R and reinforcement part 10c.

In this way, due to fulcrum part 20 and fixing part 21 adapted to fix front guard 10, the stress applied on front guard 10 is dispersed into the two directions, i.e., vertical and horizontal directions, thereby improving the durability of front guard 10.

Further, due to this structure, even if the clearance exists between pin 16 and the penetrating holes and front guard 10 cannot be fixed stably, front guard 10 is provided with enough resistance against shock.

In this way, the lower portion of front guard 10 is fore-and-aft rotatably supported on bracket 11, and the rotation stopper (i.e., reinforcement part 10c) is formed in the lower rear portion of front guard 10. Reinforcement part 10c is substantially L-like shaped when viewed in side so as to have rear surface 10e and lower surface 10f. Rear surface 10e is adapted to contact the front surface of the vehicle body frame. Lower surface 10f is adapted to contact the upper surface of the bracket. Accordingly, when front guard 10 touches an obstacle, the stress applied on front guard 10 is dispersed into vertical and horizontal directions, thereby ensuring high rigidity of front guard 10.

As shown in FIG. 8, front guard 10 is rotatably supported centering on bolt 12, and can be rotated forward when pin 16 is removed.

As shown in FIG. 9, when front guard 10 is rotated forward so as to touch the ground surface, front guard 10 serves as a ladder spanned from the ground surface to bonnet 30 and can be used as a step having horizontal frames 10b serving as bridges.

Accordingly, during maintenance of bonnet 30, front guard 10 does not obstruct the maintenance and allows easy access to bonnet 30, whereby the workability of the maintenance is improved.

In this way, front guard 10 is formed into a substantially ladder-like shape, and the lower portion of front guard 10 is fore-and-aft rotatably supported on bracket 11 so that front guard 10 rotated forwardly downward serves as a step, so as to facilitate access to bonnet 30 for viewing the interior of bonnet 30, whereby the workability of the maintenance is improved.

Description of the state of the working vehicle equipped with the front guard as the subject of the invention is concluded.

### INDUSTRIAL APPLICABILITY

The front guard of a working vehicle according to the invention is adaptable to working vehicles and other type vehicles such as automobiles.

1. A front guard of a working vehicle, wherein the front guard is attached to a bracket fixed to a front portion of a vehicle body frame and is arranged in front of a bonnet, wherein a front end of the front guard is disposed behind a front end of a front wheel of the working vehicle, and wherein a top of the front guard is projected slightly upward from a line of sight of an operator on an operation seat toward an upper front portion of the bonnet so as to be seen by the operator, and so as not to obstruct the operator's eyeshot.

2. The front guard of the working vehicle as set forth in claim 1, wherein the front guard comprises a vertical frame extended vertically and a horizontal frame extended horizontally, and wherein a triangular reinforcement part is provided on a front or rear surface of the vertical frame.

3. The front guard of the working vehicle as set forth in claim 1, wherein a lower portion of the front guard is rotatably forward supported on the bracket, wherein a rotation stopper is formed in a lower rear portion of the front guard, wherein the rotation stopper is substantially L-like shaped when viewed in side so as to have a rear surface and a lower surface, wherein the rear surface of the rotation stopper is adapted to contact a front surface of the vehicle body frame, and wherein the lower surface of the rotation stopper is adapted to contact an upper surface of the bracket.

4. The front guard of the working vehicle as set forth in claim 1, wherein the bracket comprises left and right independent members.

5. The front guard of the working vehicle as set forth in claim 1, wherein the front guard is formed into a substantially ladder-like shape, and wherein a lower portion of the front guard is fore-and-aft rotatably supported on the bracket so that the front guard rotated forwardly downward serves as a step.

6. The front guard of the working vehicle as set forth in claim 1, wherein a lower portion of the front guard is fore-and-aft rotatably supported on the bracket, wherein a pin is inserted into holes penetrating both of the front guard and the bracket so as to fix the front guard to the bracket, and wherein clearance is formed between the penetrating holes and the pin.

7. The front guard of the working vehicle as set forth in claim 1, wherein the front guard comprises a vertical frame extended vertically and a horizontal frame extended horizontally, and wherein the vertical frame is offset from an upright part of a bonnet grill when viewed in front.

8. (canceled)
